(19) United States
(12) Patent Application Publication
(10) Pub. No.: US 2025/0259035 A1
(43) Pub. Date: Aug. 14, 2025

(54) SYSTEM AND METHOD FOR PROVIDING ARTIFICIAL INTELLIGENCE (AI)-GENERATED CONTENT AND QUESTION AND ANSWER INTERFACE

(71) Applicant: Yahoo Assets LLC, New York, NY (US)

(72) Inventors: Sanika Shirwadkar, Milpitas, CA (US); Eliyar Asgarieh, Mountain View, CA (US); Chinmay Rane, Dublin (IE); Akshay Bahadur, Scottsdale, AZ (US); Lakshmi V Kesiraju, San Jose, CA (US); Xue Wu, San Jose, CA (US); Paloma de Juan, New York, NY (US)

(21) Appl. No.: 18/436,069

(22) Filed: Feb. 8, 2024

(51) Int. Cl. G06N 3/0455

(52) U.S. Cl. CPC G06N 3/0455

(57) ABSTRACT

In accordance with the present disclosure, one or more computing devices and/or methods are provided. In an example, a first group of content items may be identified. A content interface may be provided for display on a client device. The content interface may comprise a first selectable input for accessing a first content item of the first group of content items, a second selectable input for accessing a second content item of the first group of content items, and/or a question and answer interface. A query may be received via the question and answer interface. Using a generative AI tool, a response to the query may be generated based upon the first group of content items. A representation of the response to the query may be displayed via the question and answer interface.

### BACKGROUND

Many services, such as websites, applications, etc. may provide platforms for navigating through various media items. For example, a user may interact with a search interface to find search results for a query.

### SUMMARY

In accordance with the present disclosure, one or more computing devices and/or methods are provided. In an example, a pool of content items may be identified. The pool of content items may be analyzed based upon a set of features to group two or more content items of the pool of content items into a first group of content items, wherein the set of features comprise a set of salient entities, a set of publication dates, a set of content sources and/or a set of content similarities. Using a generative artificial intelligence (AI) tool, an AI-generated content item based upon the first group of content items may be generated. A content interface may be provided for display on a client device. The content interface may comprise a first selectable input for accessing a first content item of the first group of content items, a second selectable input for accessing a second content item of the first group of content items, and/or a representation of the AI-generated content item.

In an example, a first group of content items may be identified. A content interface may be provided for display on a client device, wherein the content interface may comprise a first selectable input for accessing a first content item of the first group of content items, a second selectable input for accessing a second content item of the first group of content items, and/or a question and answer interface. A query may be received via the question and answer interface. Using a generative AI tool, a response to the query may be generated based upon the first group of content items. A representation of the response to the query may be displayed via the question and answer interface.

In an example, a pool of content items may be identified. The pool of content items may be analyzed based upon a set of features to group two or more content items of the pool of content items into a first group of content items. Using a first generative AI tool, an AI-generated content item based upon the first group of content items may be generated. A content interface may be provided for display on a client device, wherein the content interface may comprise a representation of the AI-generated content item, and/or a question and answer interface. A query may be received via the question and answer interface. Using a second generative AI tool, a response to the query may be generated. A representation of the response to the query may be displayed via the question and answer interface.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing Artificial Intelligence (AI)-generated content and/or a question and answer interface.

FIG. 5A is a component block diagram illustrating an example system for providing AI-generated content and/or a question and answer interface, where a search interface is displayed on a first client device.

FIG. 5B is a component block diagram illustrating an example system for providing AI-generated content and/or a question and answer interface, where a pool of content items are identified based upon a query.

FIG. 5C is a component block diagram illustrating an example system for providing AI-generated content and/or a question and answer interface, where content items are grouped into groups of content items.

FIG. 5D is a component block diagram illustrating an example system for providing AI-generated content and/or a question and answer interface, where an AI-generated content item is generated.

FIG. 5E is a component block diagram illustrating an example system for providing AI-generated content and/or a question and answer interface, where a content interface is displayed on a first client device.

FIG. 5F is a component block diagram illustrating an example system for providing AI-generated content and/or a question and answer interface, where a representation of an AI-generated content item is displayed on a first client device.

FIG. 5G is a component block diagram illustrating an example system for providing AI-generated content and/or a question and answer interface, where a content interface is displayed on a first client device.

FIG. 5H is a component block diagram illustrating an example system for providing AI-generated content and/or a question and answer interface, where a content interface is displayed on a first client device.

FIG. 6 is a component block diagram illustrating an example system for providing AI-generated content and/or a question and answer interface.

FIG. 7 is a component block diagram illustrating an example system for providing AI-generated content and/or a question and answer interface.

FIG. 8 is a flow chart illustrating an example method for providing AI-generated content and/or a question and answer interface.

FIG. 9 is a flow chart illustrating an example method for providing a question and answer interface.

FIG. 10 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

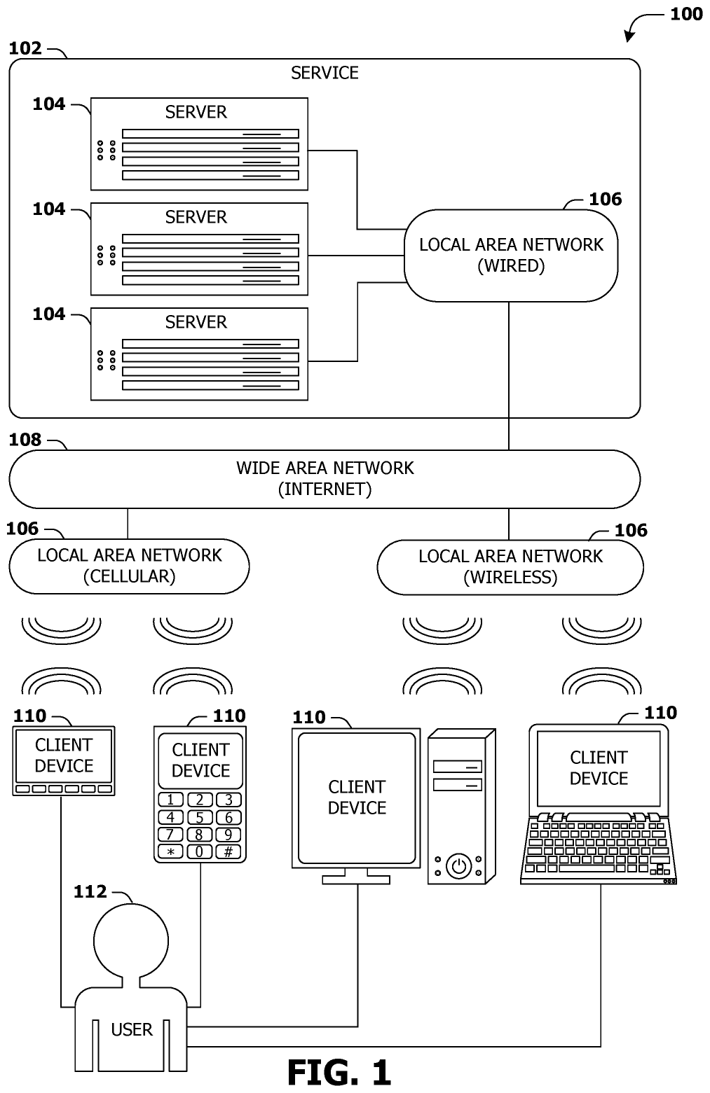

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

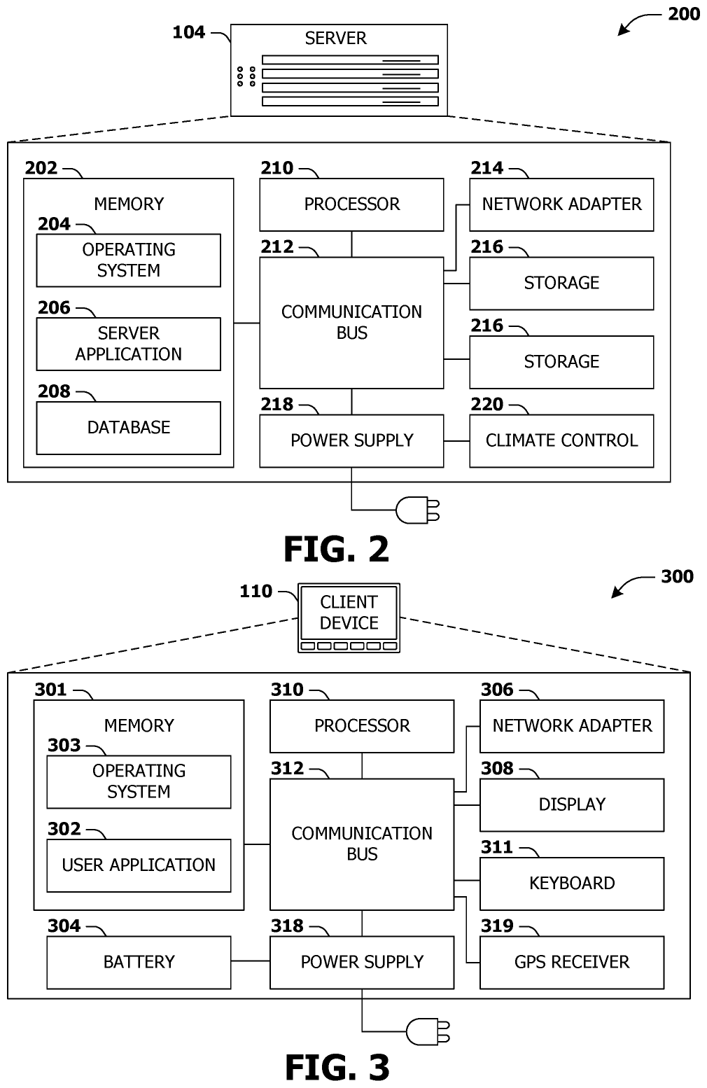

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for providing artificial intelligence (AI)-generated content and/or a real-time contextual question answering service are provided. In an example, a pool of content items may be analyzed to group two or more content items into a group of content items. Using a generative AI tool, an AI-generated content item may be generated based upon the first group of content items. For example, the AI-generated content item may comprise a summary of the first group of content items. A content item may be displayed on a client device. The content interface may comprise selectable inputs for accessing content items of the first group of content items, a second selectable input for accessing a second content item of the first group of content items, a representation of the AI-generated content item, and/or a question and answer interface. A query may be received via the question and answer interface. A response to the query may be generated using a second generative AI tool and displayed via the question and answer interface.

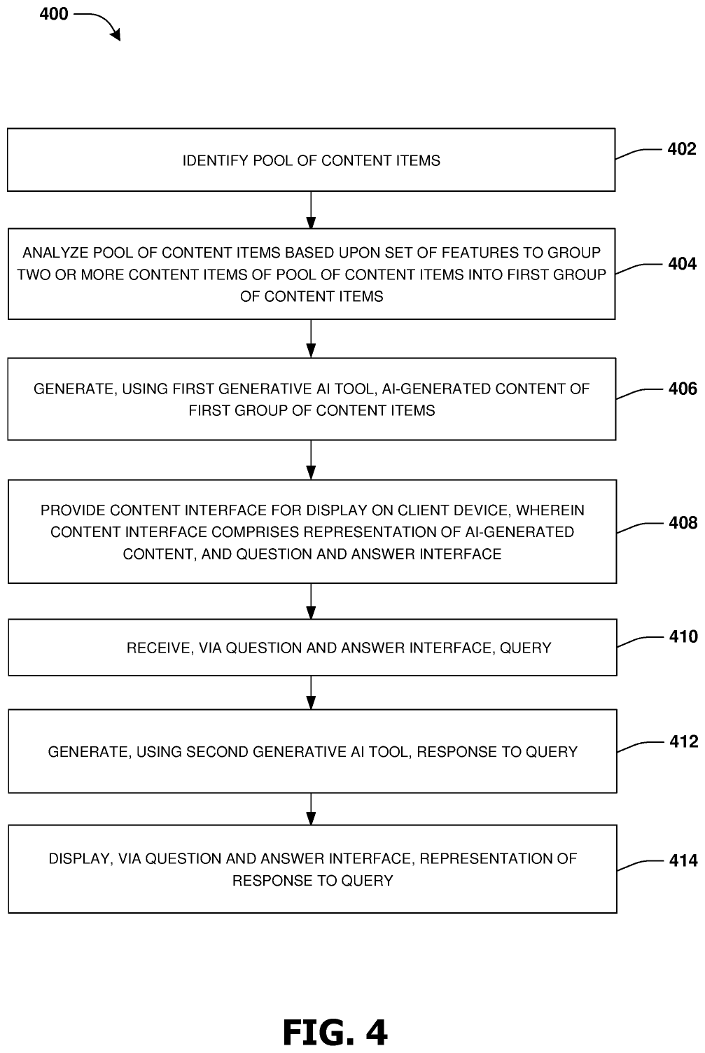

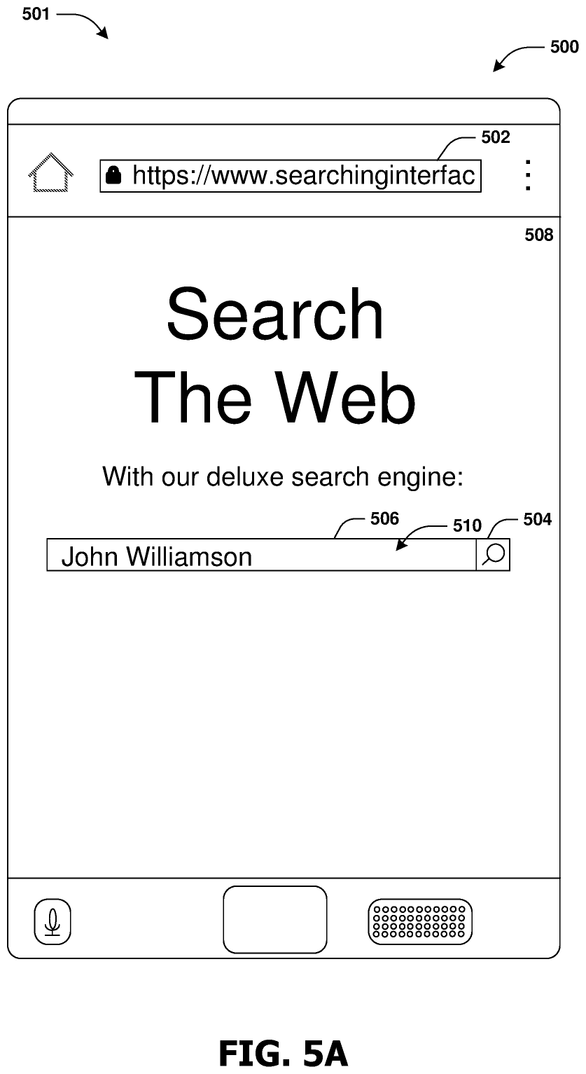

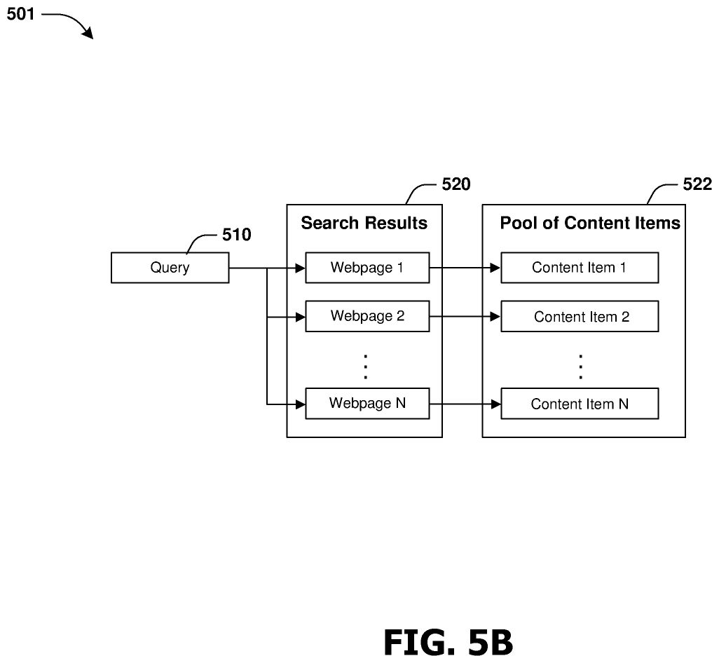

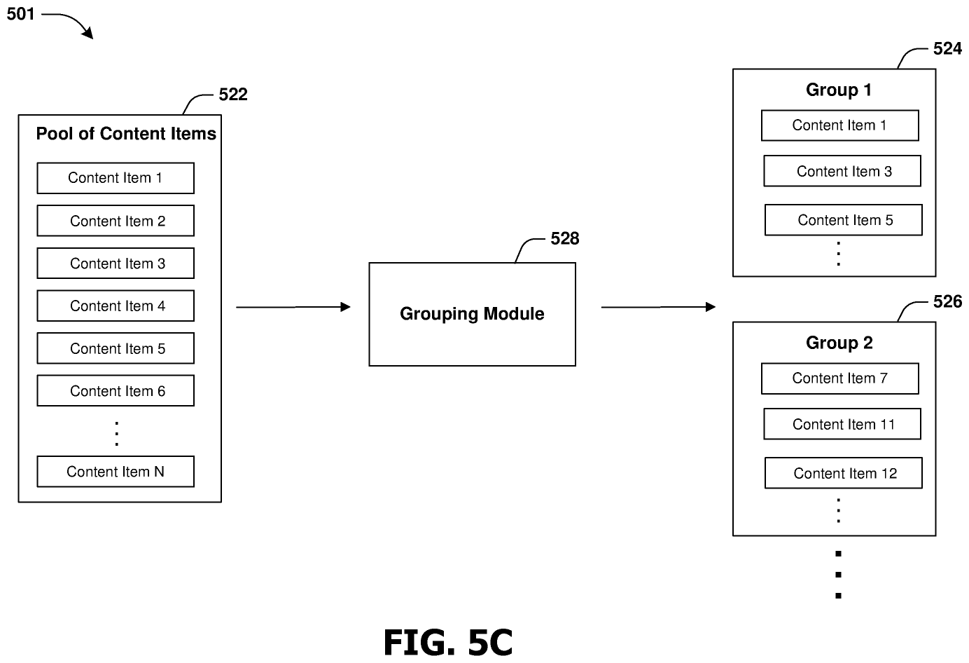

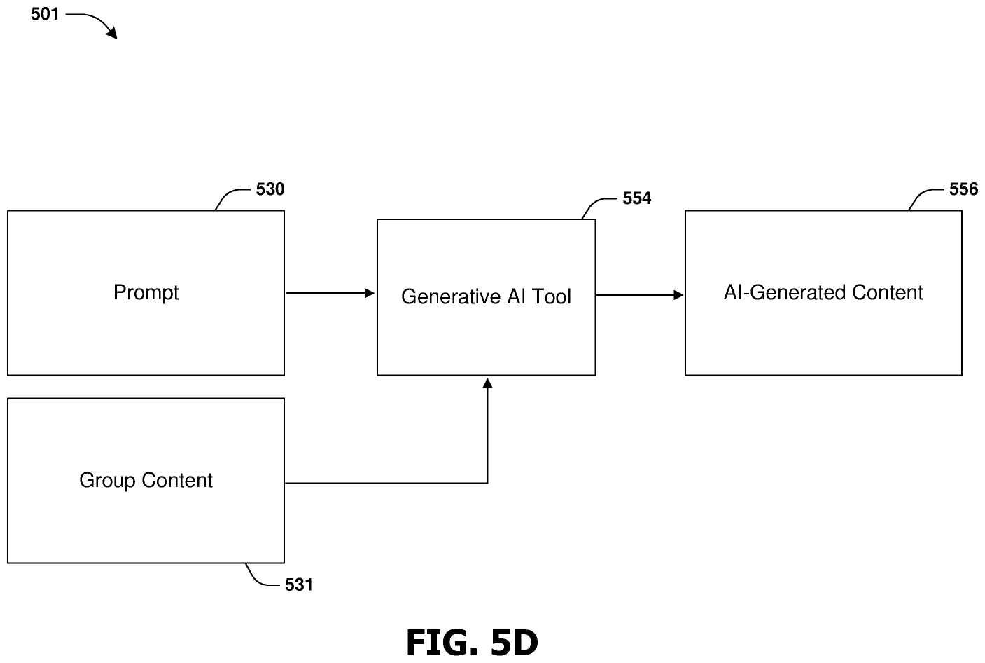

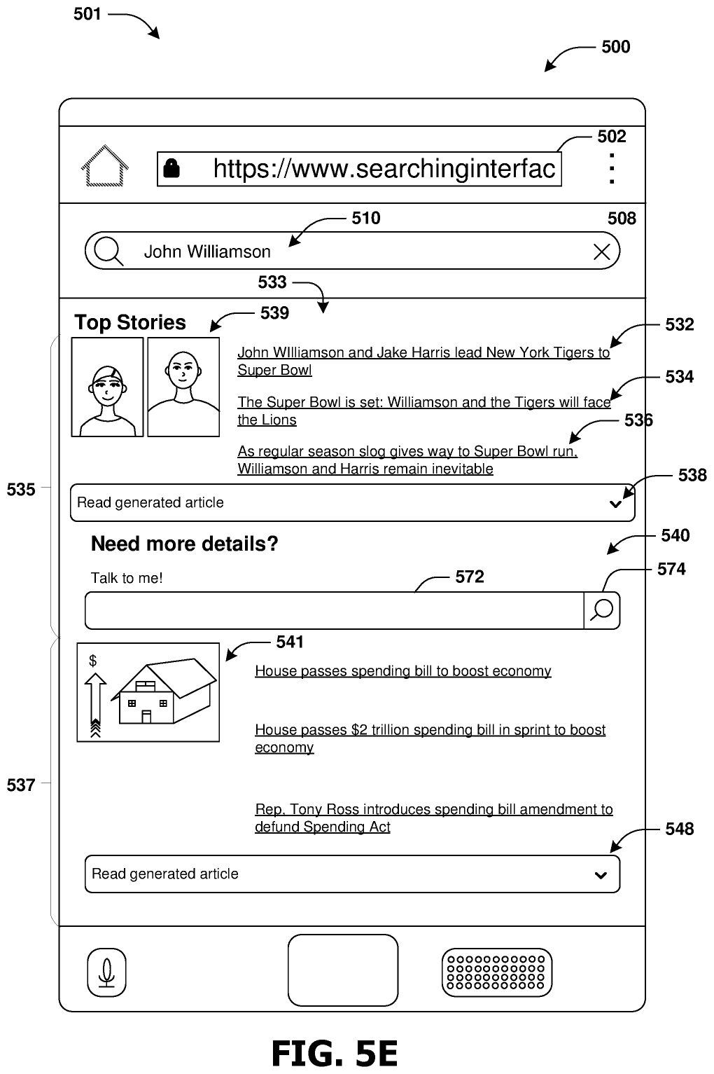

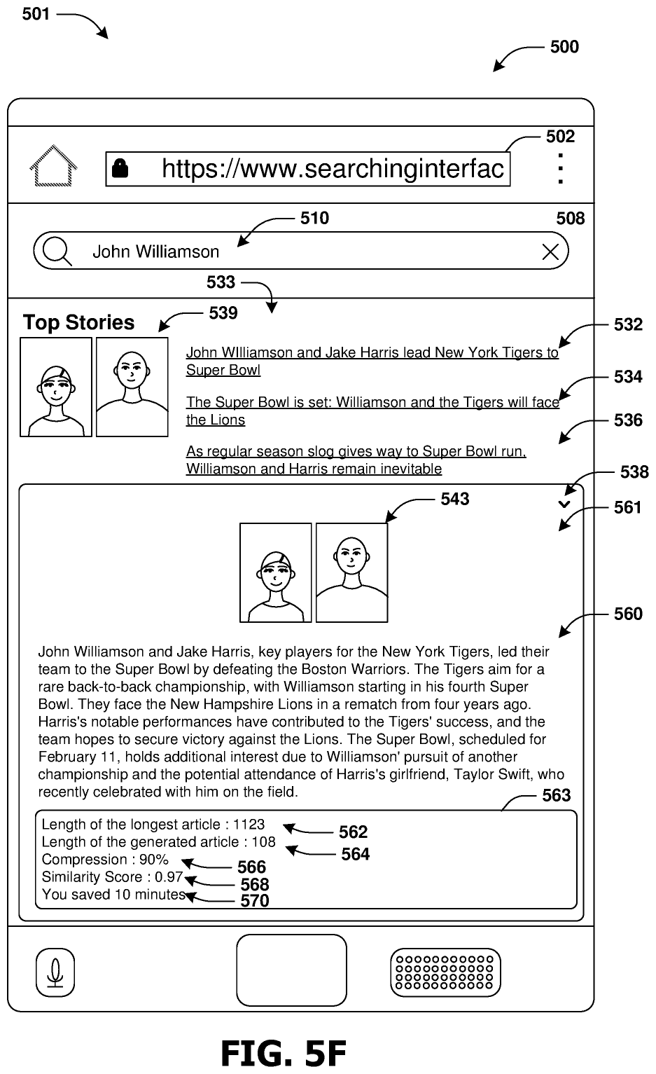

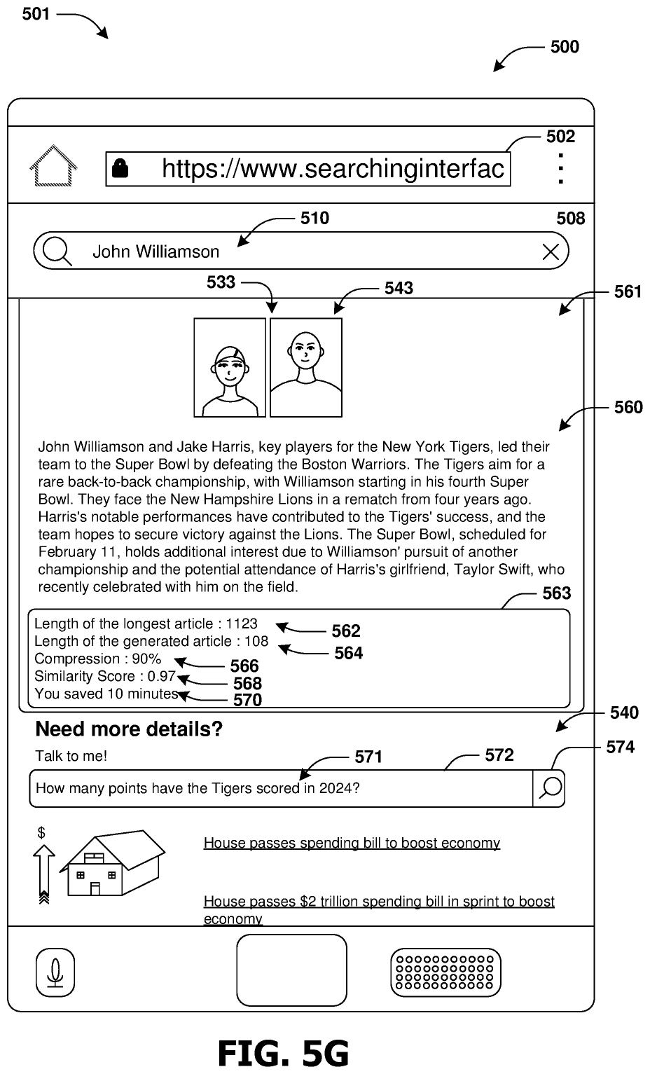

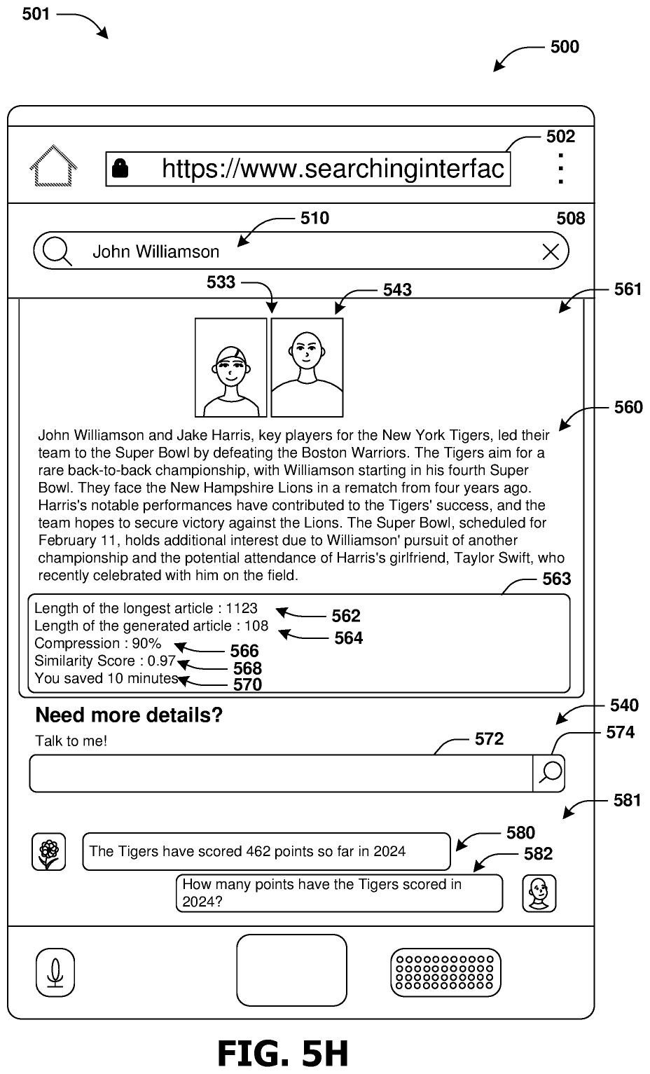

An embodiment of providing AI-generated content and/or a question and answer interface is illustrated by an example method 400 of FIG. 4, and is further described in conjunction with a system 501 of FIGS. 5A-5H. In some examples, a content system is provided. A first user, such as user Jill, (and/or a first client device associated with the first user) may access and/or interact with a service, such as a browser, software, a website, an application, an operating system, an email interface, a messaging interface, a music-streaming application, a video application, a news application, etc. that provides a platform for viewing and/or downloading content items (e.g., sets of text, images, audio, videos, etc.) from a server associated with the content system. In some examples, the content system may use user information, such as a first user profile comprising activity information (e.g., search history information, website browsing history, email information, selected content items, etc.), demographic information associated with the first user, location information, etc. to determine interests of the first user and/or select content for presentation to the first user based upon the interests of the first user.

At 402, the content system may identify a pool of content items. In some examples, the pool of content items may be identified (in real time, for example) based upon search results generated based upon a first query received from the first client device. In some examples, the content system may receive the first query via a search interface displayed on the first client device. In some examples, the content system may provide a search engine used to provide search results in response to queries received via the search interface. FIG. 5A illustrates the first client device (shown with reference number 500) presenting and/or accessing the search interface (shown with reference number 508). The first client device 500 may comprise at least one of a phone, a laptop, a computer, a wearable device, a smart device, a television, any other type of computing device, hardware, etc. The search interface 508 may be displayed via a web page using a browser of the first client device 500. The browser may comprise an address bar 502 comprising a web address (e.g., a URL) of the web page. The search interface 508 may be associated with the search engine (e.g., a web search engine designed to search for information throughout the Internet). In some examples, the search interface 508 may comprise a search field 506. For example, the first query (shown with reference number 510) may be entered into the search field 506. In an example, the first query 510 may comprise text (e.g., “James Williamson”). In some examples, the search interface 508 may comprise a search selectable input 504 corresponding to performing a search based upon the first query 510. The content system may receive the first query 510 in response to a selection of the search selectable input 504.

The content system (e.g., the search engine of the content system) may generate a plurality of search results corresponding to a first plurality of internet resources associated with the first query 510. An internet resource of the first plurality of internet resources may correspond to a web page and/or at least a portion of an application (e.g., a web application, a mobile application, etc.). In some examples, the plurality of search results may be generated based upon a determination that one or more parts of the first query 510 matches one or more parts of each internet resource of the first plurality of internet resources. In some examples, the plurality of search results may be ranked based upon levels of relevance to the first query 510. In some examples, the plurality of search results may comprise a subset of a second plurality of search results determined for the first query 510. For example, the plurality of search results may comprise a set of top N ranked search results among the second plurality of search results. N may be between at least 5 (e.g., top 5 ranked search results) and at most 15 (e.g., top 15 ranked search results). Other values of N are within the scope of the disclosure. Content items may be extracted from the first plurality of internet resources for inclusion in the pool of content items. FIG. 5B illustrates extracting content items from webpages of the plurality of search results (shown with reference number 520) for inclusion in the pool of content items (shown with reference number 522).

In some examples, the pool of content items 522 may be identified (via offline processing, for example) using a content item fetcher of the content system. For example, the content item fetcher may scan a second plurality of internet resources (e.g., web pages, databases accessible via the Internet, etc.) to identify content items (e.g., articles, videos, audio files, etc.) provided by internet resources of the second plurality of internet resources. The content item fetcher may extract the content items from the internet resources for inclusion in the pool of content items 522.

At 404, the content system may analyze the pool of content items 522 based upon a set of features (e.g., a set of one or more features) to group two or more content items of the pool of content items 522 into a first group of content items. In some examples, the set of features may comprise (i) a set of salient entities (e.g., a set of one or more salient entities), (ii) a set of publication dates (e.g., a set of one or more publication dates), (iii) a set of content sources (e.g., a set of one or more content sources) and/or (iv) a set of content similarities (e.g., a set of one or more content similarities).

In some examples, the set of salient entities may comprise salient entities associated with content items of the pool of content items 522. The set of salient entities may comprise a first set of salient entities (e.g., a first set of one or more salient entities) associated with a first content item of the pool of content items 522, a second set of salient entities (e.g., a second set of one or more salient entities) associated with a second content item of the pool of content items 522, etc. In some examples, the first content item of the pool of content items 522 may be analyzed to determine the first set of salient entities. In some examples, the first set of salient entities may be determined by analyzing the first content item (e.g., an article comprising text) using one or more natural language processing (NLP) techniques and/or one or more text analysis techniques. Alternatively and/or additionally, the first set of salient entities may be determined based upon a list of salient entities associated with the first content item. The list of salient entities may be included in at least one of the first content item, metadata of the first content item, etc. In some examples, the first content item (and/or metadata of the first content item) may be scanned for the list of salient entities. The first content item may be analyzed using NLP techniques and/or text analysis techniques to determine the first set of salient entities in response to determining that the list of salient entities was not found and/or is not available.

A salient entity of the first set of salient entities may correspond to an entity, referred to in the first content item, that is determined (by the content system, for example) to be important and/or relevant to the first content item (e.g., more important and/or relevant than other entities referred to in the first content item), wherein the salient entity may stand out to a user consuming the first content item. In an example, the salient entity may correspond to (i) a place (e.g., country, city, geographic location, etc.), (ii) a person (e.g., a person of a particular location, a person with a particular occupation, a politician, a celebrity, a socialite, etc.), (iii) a thing (e.g., device, natural object, etc.), (iv) an organization, (v) a company, (vi) a stock symbol, (vii) a ticker symbol, (viii) an idea, (ix) a system, (x) an object (e.g., an abstract object and/or a physical object), (xi) an event such as a historical event and/or a current event, (xii) a concept, and/or (xiii) other type of entity. An entity may be determined to be a salient entity by (i) determining a relevance score (e.g., aboutness score) indicative of a level of relevance of the entity relative to the first content item and/or (ii) comparing the relevance score with a relevance score threshold (e.g., the entity may be determined to be a salient entity based upon the relevance score exceeding the relevance score threshold).

In some examples, content items may be grouped into the first group of content items based upon a determination that the content items share one or more common salient entities. For example, the first content item and the second content item may be grouped into the first group of content items based upon a determination that one, some and/or all salient entities of the first set of salient entities associated with the first content item match (e.g., is the same as) one, some and/or all salient entities of the second set of salient entities associated with the second content item.

In some examples, the set of publication dates may comprise publication dates associated with content items of the pool of content items 522. The set of publication dates may comprise a first publication date associated with the first content item, a second publication date associated with the second content item, etc. In some examples, the first publication date may correspond to a date (indicating a time and/or day) when the first content item was published. The second publication date may correspond to a date (indicating a time and/or day) when the second content item was published. In some examples, content items may be grouped into the first group of content items based upon a determination that the content items are associated with publication dates that (i) correspond to the same day (e.g., the first publication date and the second publication date are both on a specific day, such as Jan. 26, 2024), and/or (ii) are within a threshold duration of time of each other (e.g., when the threshold duration of time is 48 hours, publication dates of content items of the first group of content items are at most about 48 hours apart from each other).

In some examples, the set of content sources may comprise content sources associated with content items of the pool of content items 522. The set of content sources may comprise a first content source associated with the first content item, a second content source associated with the second content item, etc. In some examples, the first content source may correspond to a source of the first content item, such as a publication source, a producer, a content creator, a news organization, etc. that published, produced and/or created the first content item. The second content source may correspond to a source of the second content item, such as a publication source, a producer, a content creator, a news organization, etc. that published, produced and/or created the second content item. In some examples, content items may be grouped into the first group of content items based upon a determination that the content items are associated with different content sources, which may provide for increased diversity of content items of the first group of content items. In an example, the first content item and the second content item may be grouped into the first group of content items based upon a determination that the first content source is different than the second content source.

In some examples, the set of content similarities may comprise content similarities associated with pairs of content items of the pool of content items 522. The set of content similarities may comprise a first content similarity between the first content item and the second content item, a second content similarity between the first content item and a third content item of the pool of content items 522, a fourth content similarity between the second content item and the third content item, etc. In some examples, content items may be grouped into the first group of content items based upon a determination that the content items are associated with content similarities that exceed a threshold content similarity. In an example, the first content item and the second content item may be grouped into the first group of content items based upon a determination that the first content similarity exceeds the threshold content similarity.

In some examples, the first content similarity may correspond to a similarity score (e.g., a first cosine similarity) reflective of a level of similarity between the first content item and the second content item. In an example, the first content item may be compared with the second content item to determine the first content similarity. In an example, the first content item may comprise a first article (e.g., a first news article, a first educational article, a first blog, etc.) and the second content item may comprise a second article (e.g., a second news article, a second educational article, a second blog, etc.). In some examples, the first content similarity may be determined based upon at least one of a measure (e.g., quantity) of words that are common to the first article and the second article, a measure (e.g., quantity) of phrases that are common to the first article and the second article, etc. Alternatively and/or additionally, the first content similarity may be determined by generating a first article representation (e.g., a vector representation and/or an embedding based representation) of the first article and/or a second article representation (e.g., a vector representation and/or an embedding based representation) of the second article, wherein one or more operations (e.g., mathematical operations) may be performed using the first article representation and the second article representation to determine the first content similarity (e.g., the first content similarity may be based upon (and/or may be equal to) a measure of similarity between the first article representation and the second article representation, such as a cosine similarity between the first article representation and the second article representation). In some examples, other content similarities of the set of content similarities may be determined using one or more of the techniques provided herein with respect to determining the first content similarity.

In some examples, the set of features based upon which content items are grouped into the first group of content items may comprise other types of features, such as topics of content items (e.g., a topic which a content item is about), content item categories (e.g., a category of a content item, such as entertainment, politics, world news, cuisine, etc.), search query (e.g., the first query 510 and/or other queries) and/or other features.

FIG. 5C illustrates grouping content items of the pool of content items 522 into one or more groups of content items comprising the first group of content items (shown with reference number 524), a second group of content items 526 and/or one or more other groups of content items. For example, a grouping module 528 of the content system may be used to group content items into the one or more groups of content items (based upon the set of features, for example). For example, the grouping module 528 may group the first content item (e.g., “Content Item 1” in FIG. 5C), the second content item (e.g., “Content Item 3” in FIG. 5C), the third content item (e.g., “Content Item 5” in FIG. 5C) and/or one or more other content items into the first group of content items 524.

At 406, the content system may use a first generative AI tool to generate a first AI-generated content item of the first group of content items 524. FIG. 5D illustrates the first generative AI tool (shown with reference number 554) being used to generate the first AI-generated content item (shown with reference number 556) based upon content 531 of the first group of content items 524. In some examples, the first generative AI tool 554 may comprise a language model, such as large language model (LLM). In some examples, the first generative AI tool 554 is configured to generate a content item (e.g., an article, such as a customized article, a summary, etc. wherein the content item may comprise text and/or at least one of images, audio, video, etc., for example) based upon an input. In some examples, the first AI-generated content item 556 may comprise a summary of the first group of content items 524, an article based upon the first group of content items 524 (e.g., a customized article that focuses on one or more entities of the set of salient entities), entity-focused content (e.g., content that focuses on one or more entities of the set of salient entities) and/or other type of content.

In some examples, the first generative AI tool 554 comprises one or more machine learning models (e.g., generative machine learning models). In some examples, the one or more machine learning models may comprise one or more generative pre-trained transformer models. In some examples, the one or more machine learning models may comprise one or more text generation models (to generate text of the first AI-generated content item 556, for example).

In some examples, the first generative AI tool 554 may be trained (e.g., pre-trained) and/or fine-tuned using one or more datasets (e.g., a knowledge base for generating text) to enable the first generative AI tool 554 to understand language context and/or generate text. The one or more datasets may comprise at least one of a corpus, such as a text corpus, one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc.) and/or other resources, which may enable the first generative AI tool 554 to develop a deep understanding of language context, thereby enabling the content system to comprehend users' queries (e.g., search queries with questions and/or requests) more accurately and/or leading to better summarization results.

In some examples, the content 531 input to the first generative AI tool 554 to generate the first AI-generated content item 556 comprises unmodified versions of one, some and/or all content items of the first group of content items 524. Alternatively and/or additionally, the content 531 may comprise core content extracted from one, some and/or all content items of the first group of content items 524. For example, the content 531 may comprise first core content of the first content item, second core content of the second content item, third core content of the third content item and/or core content of one or more other content items into the first group of content items 524. In an example, the first core content may be extracted from the first content item using a content extraction model of the content system. In some examples, the content extraction model may (i) access the first content item, which may comprise internet resource data a first internet resource (of the first plurality of internet resources and/or the second plurality of internet resources, for example) from which the first content item is extracted (e.g., the internet resource data may comprise raw webpage data, such as raw HyperText Markup Language (HTML) data) and/or (ii) extract the first core content (e.g., readable content, such as human readable content), from the internet resource data. In some examples, the content system may identify (using the content extraction model, for example) undesired data in the internet resource data and/or may not include the undesired data in the first core content. The undesired data may include at least one of structural elements (e.g., <head>, <body>, <nav>, <section>, etc.), text content (e.g., <p>, <h1>, <h2>, <div>, etc.), links (e.g., navigation links), headers, images, videos, media, metadata and/or other data. In some examples, excluding the undesired data from the first core content may provide for reduced noise of the first core content and/or reduced irrelevant information for content generation.

In some examples, the first generative AI tool 554 generates the first AI-generated content item 556 based upon a first prompt 530 (e.g., a set of guidance information) input to the first generative AI tool 554. The first prompt 530 may comprise instructions (e.g., chain-of-thought (COT) instruction) based upon which the first generative AI tool 554 may generate the first AI-generated content item 556 based upon the content 531. In an example, the first prompt 530 may comprise an instruction to summarize the content 531 to generate the first AI-generated content item 556 (comprising a summary of the content 531, for example). In some examples, the first AI-generated content item 556 may be generated (using the first generative AI tool 554) based upon one or more first entities of the set of salient entities. The one or more first entities may comprise one or more salient entities determined to be associated with content items of the first group of content items 524, such as (i) one or more entities of the first set of salient entities associated with the first content item, (ii) one or more entities of the second set of salient entities associated with the second content item, and/or (iii) one or more other salient entities associated with one or more other content items of the first group of content items 524. Alternatively and/or additionally, the one or more first entities may be based upon the first query 510 (e.g., the one or more first entities may include person “John Williamson” based upon the first query 510 comprising an indication of the person). In some examples, the first prompt 530 may comprise an instruction to generate the first AI-generated content item 556 to focus on the one or more first entities. Alternatively and/or additionally, the first prompt 530 may comprise an instruction to produce a summary, of the content 531, that focuses on the one or more first entities (e.g., an instruction to summarize the content 531 with a focus on the one or more first entities). In an example in which the one or more first entities include a person “John Williamson”, a person “Jake Harris” a sports team “New York Tigers” and an event “Super Bowl”, the first prompt 530 may comprise <Provide a news summary focused on “John Williamson”, “Jake Harris”, “New York Tigers” and “Super Bowl” using the following sources: Source 1, Source 2, Source 3>, where (i) “Source 1” may correspond to the first content item and/or the first core content, (ii) “Source 2” may correspond to the second content item and/or the second core content, and/or (iii) “Source 3” may correspond to the third content item and/or the third core content. In some examples, based upon the one or more first entities, the first generative AI tool 554 may (i) generate the first AI-generated content item 556 to have more content about the one or more first entities than other entities, and/or (ii) generate the first AI-generated content item 556 to include content about each entity of the one or more first entities.

At 408, the content system may provide a content interface for display on the first client device 500. The content interface may comprise selectable inputs for accessing content items of the first group of content items 524 and/or a representation of the first AI-generated content item 556. FIG. 5E illustrates the content interface (shown with reference number 533) being displayed on the first client device 500. In some examples, the content interface 533 comprises a list of search results curated based upon the first query 510. In some examples, the content interface 533 may comprise a news feed that may or may not be curated based upon a query (e.g., the first query 510) received from the first client device 500.

In some examples, the content interface 533 (e.g., the news feed and/or the list of search results) may comprise a plurality of interface sections associated with a plurality of groups of content items, such as a first interface section 535 associated with the first group of content items 524, a second interface section 537 associated with the second group of content items 526, and/or one or more other interface sections associated with one or more other groups of content items. In some examples, the plurality of interface sections may be associated with different stories (e.g., a story may correspond to one or more events and/or one or more entities that are interrelated). For example, the first interface section 535 (and/or the first group of content items 524) may be associated with a first story (e.g., a story involving a sports team competing in an event), the second interface section 537 (and/or the second group of content items 526) may be associated with a second story (e.g., a story involving an economic spending bill being passed), and/or other interface sections may be associated with other stories.

In some examples, the first interface section 535 of the content interface 533 may comprise (i) a first selectable input 532 for accessing the first content item of the first group of content items 524, (ii) a second selectable input 534 for accessing the second content item of the first group of content items 524, (iii) a third selectable input 536 for accessing the third content item of the first group of content items 524, (iv) a fourth selectable input 538 (e.g., an expand button) for accessing the first AI-generated content item 556, (v) a question and answer interface 540 for a user to submit one or more queries (e.g., questions associated with the first story), and/or (vi) one or more graphical objects 539 (e.g., one or more images that may be associated with the first story and/or may be extracted from one or more content items of the first group of content items 524). In an example, the first selectable input 532 may comprise a link (e.g., a uniform resource locator (URL)) pointing to the first internet resource (e.g., a web page, a web application, etc.) comprising the first content item. In some examples, in response to a selection of the first selectable input 532, the first content item is displayed on the first client device 500 (e.g., the first client device 500 may be directed to the first internet resource in response to the selection).

In some examples, the second interface section 537 of the content interface 533 may comprise (ii) selectable inputs for accessing content items of the second group of content items 526, (ii) a fifth selectable input 548 for accessing a second AI-generated content item generated based upon the second group of content items 526 (e.g., a summary of the second group of content items 526), (iii) a second question and answer interface (not shown) for a user to submit one or more queries (e.g., questions associated with the second story), and/or (iv) one or more graphical objects 541 (e.g., one or more images that may be associated with the second story and/or may be extracted from one or more content items of the second group of content items 526).

In some examples, the content interface 533 may comprise a representation 561 of the first AI-generated content item 556. FIG. 5F illustrates the content interface 533 displaying the representation 561 of the first AI-generated content item 556. In some examples, the representation 561 of the first AI-generated content item 556 may be displayed in response to a selection of the fourth selectable input 538. In some examples, the representation 561 of the first AI-generated content item 556 may comprise one or more graphical objects 543, a set of text 560 (e.g., article text, summary text, etc.), and/or a set of metrics 563 (e.g., a set of one or more metrics) associated with the first group of content items 524 and the first AI-generated content item 556. In some examples, the one or more graphical objects 543 may be extracted from one or more content items of the first group of content items 524. The one or more graphical objects 543 may be the same as or different than the one or more graphical objects 539. In some examples, the one or more graphical objects 543 may comprise an AI-generated graphical object (e.g., an AI-generated image).

In some examples, the content system may determine at least some of the set of metrics 563 based upon a comparison of the first AI-generated content item 556 with one, some, or all content items of the first group of content items 524 (and/or with at least some of the content 531). For example, the set of metrics 563 may include (i) a first metric 562 corresponding to a length (e.g., word count) of a content item (e.g., a longest content item) of the first group of content items 524 (e.g., an article with the greatest word count among the first group of content items 524), (ii) a second metric 564 corresponding to a length (e.g., word count) of the first AI-generated content item 556 (e.g., a word count of the set of text 560), (iii) a third metric 566 corresponding to a compression ratio of the first AI-generated content item 556 relative to a content item (e.g., a longest content item) of the first group of content items 524 (e.g., the compression ratio may be determined based upon a length of the first AI-generated content item 556 and a length of the content item), (iv) a fourth metric 568 corresponding to a measure of similarity of the first AI-generated content item 556 relative to one, some and/or all content items of the first group of content items 524 (and/or relative to at least some of the content 531) and/or (v) a fifth metric 570 corresponding to an amount of time that a user may save (e.g., about 10 minutes) by learning about the first story by consuming the first AI-generated content item 556 as compared with consuming one, some and/or all content items of the first group of content items 524 to learn about the first story.

FIG. 5G illustrates user interaction with the question and answer interface 540 of the content interface 533. In some examples, the first user may scroll down from a first view of the content interface 533 shown in FIG. 5F to a second view of the content interface 533 shown in FIG. 5G. The question and answer interface 540 may comprise a query field 572. For example, a second query 571 may be entered into the query field 572. In an example, the second query 571 may comprise a question and/or request about the first group of content items 524, the first AI-generated content item 556 (e.g., the set of text 560), the first story, an entity (e.g., one or more entities of the one or more first entities and/or the set of salient entities) and/or other issue. In some examples, the question and answer interface 540 may comprise a selectable input 574 corresponding to providing a response based upon the second query 571.

At 410, the content system may receive the second query 571 via the question and answer interface 540. For example, the content system may receive the second query 571 in response to a selection of the selectable input 574. In an example, the second query 571 may comprise a question “How many points have the Tigers scored in 2024?”.

At 412, the content system may use a second generative AI tool to generate a first response to the second query 571. In some examples, the second generative AI tool may comprise a language model, such as large language model (LLM). In some examples, the second generative AI tool is configured to generate content (e.g., text and/or other type of content) based upon an input. In some examples, the second generative AI tool comprises one or more machine learning models (e.g., generative machine learning models) comprising one or more generative pre-trained transformer models, one or more text generation models and/or one or more other types of models. One, some and/or all machine learning models of the first generative AI tool 554 and/or the second generative AI tool may, for example, comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc. In some examples, the second generative AI tool may be trained (e.g., pre-trained) and/or fine-tuned using one or more one or more of the techniques provided herein with respect to the first generative AI tool 554.

In some examples, the second generative AI tool is different than the first generative AI tool 554. Embodiments are contemplated in which the second generative AI tool is the same as the first generative AI tool 554 (e.g., the same generative AI tool is used to generate the first AI-generated content item 556 and the first response).

In some examples, the second generative AI tool generates the first response based upon a second prompt (e.g., a set of guidance information) input to the second generative AI tool. The second prompt may comprise instructions (e.g., COT instruction) based upon which the second generative AI tool may generate the first response based upon (i) the first group of content items 524 (and/or the content 531 of the first group of content items 524), (ii) the first AI-generated content item 556 and/or (iii) a set of available information available to and/or accessed by the second generative AI tool. In an example, the second prompt may comprise (i) an indication of the second query 571 and/or (ii) an instruction to provide a response to the second query 571 using (i) the first group of content items 524 (and/or the content 531 of the first group of content items 524), (ii) the first AI-generated content item 556 and/or (iii) the set of available information. In an example, the second prompt may comprise <Provide a response to USER_QUERY using the following sources: Source 1, Source 2, Source 3, Content 1>, where (i) “Source 1” may correspond to the first content item and/or the first core content, (ii) “Source 2” may correspond to the second content item and/or the second core content, (iii) “Source 3” may correspond to the third content item and/or the third core content, (iv) “USER_QUERY” may correspond to the second query 571, and/or (v) “Content 1” may correspond to the first AI-generated content item 556. In some examples, in response to a determination that the first group of content items 524 and/or the first AI-generated content item 556 do not comprise information necessary for providing a sufficient response to the second query 571 (e.g., the first group of content items 524 and/or the first AI-generated content item 556 are not indicative of a number of points scored by a sports team), the content system (e.g., the second generative AI tool of the content system) may access the set of available information (and/or other information in one or more internet resources) to identify information that could be used to generate a sufficient response to the second query 571, and/or may use the information to generate the first response.

At 414, the content system may display, via the question and answer interface 540, a representation of the first response to the second query 571. In some examples, the representation of the first response may be displayed via a chat interface (e.g., an AI assistant interface, a chatbot interface, etc.) which may be used for displaying one or more queries (from the first user, for example) and/or one or more responses (generated by the second generative AI tool in response to the one or more queries, for example). FIG. 5H illustrates the question and answer interface 540 displaying the chat interface (shown with reference number 581) comprising the representation (shown with reference number 580) of the first response and/or a representation 582 of the second query 571. In some examples, additional queries (in addition to the second query 571) may be received after receiving the second query 571 and/or the chat interface 581 may display additional responses in response to the additional queries. For example, a third query may be received via the question and answer interface 540 and/or the second generative AI tool may be used to generate a second response to the third query. A representation of the second response (and/or a representation of the third query) may be displayed via the chat interface 581.

In some examples, the question and answer interface 540 may provide a real-time contextual question answering service that can be used within the content interface 533 without having to navigate away to a different page, thereby providing for improved user experience. For example, the question and answer interface 540 may provide precise answers to users' questions without the need for users to manually sift through online information, thereby saving time and effort.

It may be appreciated that providing the content 531 of the first group of content items 524 (which may provide contextual and/or recent information associated with developments and/or events of the first story, for example) to the first generative AI tool 554 for use in generating the first AI-generated content item 556, the first generative AI tool 554 may provide more accurate content (e.g., the first AI-generated content item 556) as compared to other systems that (merely) rely upon training datasets (that do not include up-to-date information associated with the first story, for example) to generate content.

Using the techniques provided herein may provide for benefits including improved quality of the first AI-generated content item 556, which may be due, at least in part, to using the first group of content items 524 (comprising multiple documents, for example) to generate the first AI-generated content item 556, which may provide a more complete and/or holistic view of the first story as compared to using a single document (e.g., a single article) to generate content, which may enable the first user to use the first AI-generated content item 556 to develop a more complete understanding of the first story in a relatively shorter amount of time).

Alternatively and/or additionally, it may be appreciated that using the techniques provided herein may provide for more comprehensive and/or well-rounded content that covers multiple perspectives and viewpoints (which may provide for more objective and/or impartial representation of the first story), such as due, at least in part, to content items from different content sources being grouped into the first group of content items 524 (which may provided for increased diversity of content items of the first group of content items) used to generate the first AI-generated content item 556.

In some examples, the first prompt 530 and/or the first AI-generated content item 556 may be generated based upon one or more user preferences (such that prompts and/or AI-generated content items provided by the content system may be adapted and/or customized according to individual preferences and/or allowing users to focus on desired levels of detail and/or specific aspects to tailor AI-generated content to their needs). In an example, the one or more first entities may be determined based upon a user input (e.g., the first query 510 and/or other message) received from the first client device 500. Alternatively and/or additionally, a target content length (e.g., a target word count) and/or a target level of detail may be determined based upon the user input. The first AI-generated content item 556 may be generated based upon the target content length.

In some examples, the first generative AI tool 554 may have multi-modal input and/or output capability such that the first AI-generated content item 556 may comprise a different type of content than one or more content items of the first group of content items 524, such as where (i) a content item of the first group of content items 524 comprises a video and/or the first AI-generated content item 556 comprises text, (ii) a content item of the first group of content items 524 comprises text (e.g., an article) and/or the first AI-generated content item 556 comprises a video, (iii) a content item of the first group of content items 524 comprises audio and/or the first AI-generated content item 556 comprises text, (iv) a content item of the first group of content items 524 comprises text (e.g., an article) and/or the first AI-generated content item 556 comprises audio, (v) a content item of the first group of content items 524 comprises an image and/or the first AI-generated content item 556 comprises text, (vi) a content item of the first group of content items 524 comprises text (e.g., an article) and/or the first AI-generated content item 556 comprises an image, and/or (vii) other combination of content item types. Alternatively and/or additionally, the second generative AI tool may have multi-modal input and/or output capability.

In some examples, the first generative AI model may have multi-lingual input and/or output capability such that the first AI-generated content item 556 may have a first language different than one or more second languages of one or more content items of the first group of content items 524 and/or where one or more content items of the first group of content items 524 may comprise multi-lingual text, multi-lingual video and/or multi-lingual audio. Alternatively and/or additionally, the second generative AI tool may have multi-lingual input and/or output capability.

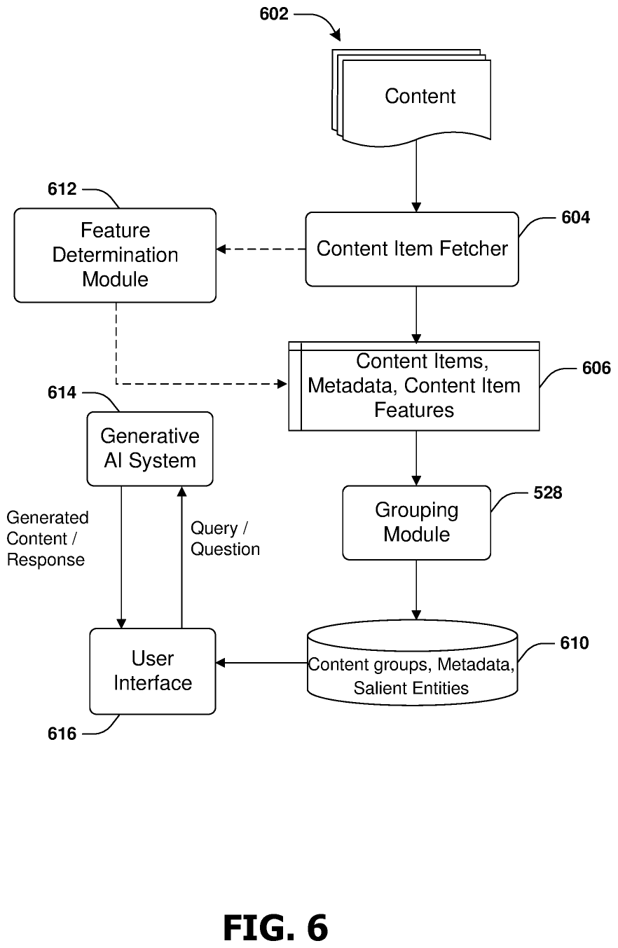

FIG. 6 illustrates a system 601 for providing AI-generated content and/or responses to queries. The content system may comprise the system 601. The system 601 may comprise the content item fetcher (shown with reference number 604), a feature determination module 612, the grouping module 528 (for grouping of articles and/or one more other types of content, for example), a data store 610, a user interface 616 and/or a generative AI system 614. In some examples, the content item fetcher 604 may retrieve content items 602 (e.g., the pool of content items 522 comprising at least one of articles, videos, audio files, etc.). The feature determination module 612 may determine content item features (e.g., salient entities, publication dates, content sources content similarities, topics of content items content item categories, etc.) associated with the content items 602. The content item fetcher 604 and/or the feature determination module 612 may provide information 606 comprising the content items 602, metadata of the content items 602 and/or the content item features associated with the content items 602 to the grouping module 528 to determine groups of content items (e.g., at least one of the first group of content items 524, the second group of content items 526, etc.). For example, the information 606 may include first information (e.g., the content items 602 and/or the metadata of the content items 602) provided by the content item fetcher 604 and/or second information (e.g., the content item features) provided by the feature determination module 612. Information comprising the content items 602, grouping information of the content items 602 (e.g., the grouping information may be indicative of groups of content items determined using the grouping module 528), metadata of the content items 602 and/or salient entities associated with the content items 602 may be stored in the data store 610. The information stored in the data store 610 may be used by the generative AI system 614 (comprising the first generative AI tool 554 and/or the second generative AI tool) to produce content (e.g., the first AI-generated content item 556 and/or the first response) to be provided via the user interface 616 (e.g., the content interface 533), such as in response to a query received via the user interface 616.

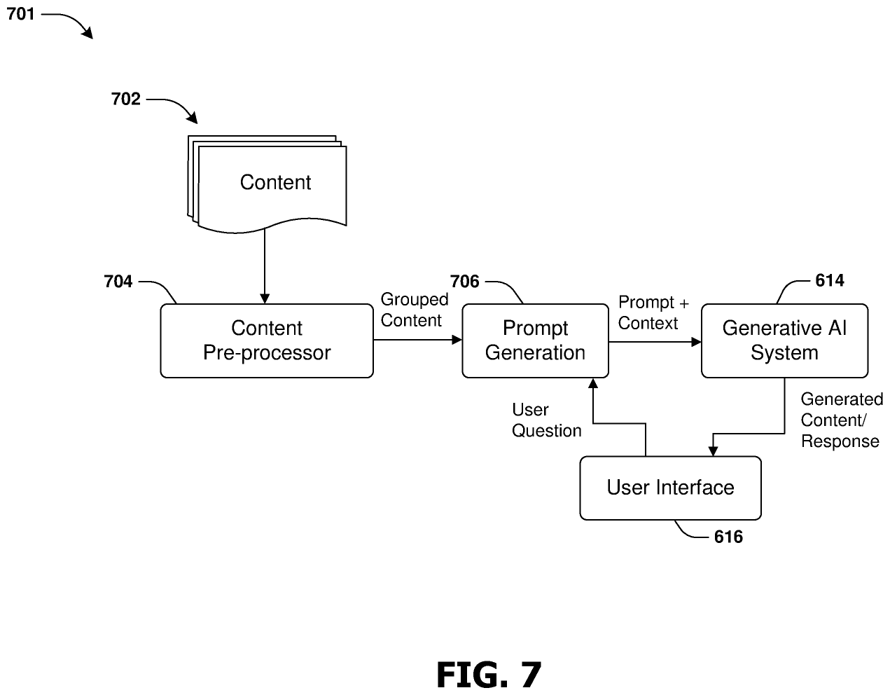

FIG. 7 illustrates a system 701 for providing AI-generated content and/or responses to queries. The content system may comprise the system 701. A content pre-processor 704 of the content system may (i) retrieve content items 702 (e.g., the pool of content items 522 comprising at least one of articles, videos, audio files, etc.), (ii) group the content items 702 into groups to generate grouped content (e.g., groups of content items comprising at least one of the first group of content items 524, the second group of content items 526, etc.), and/or (iii) provide the grouped content to a prompt generation module 706. In some examples, the prompt generation module 706 may provide a prompt (e.g., the first prompt 520, the second prompt, etc.) and/or contextual information (e.g., the first group of content items 524, the content 531, etc.) to the generative AI system 614 (comprising the first generative AI tool 554 and/or the second generative AI tool) to enable the generative AI system 614 to produce content (e.g., the first AI-generated content item 556 and/or the first response) to be provided via the user interface 616 (e.g., the content interface 533). In an example, a user question (e.g., the second query 571) may be received via the user interface 616 and/or provided to the prompt generation module 706 for use in generating a response (e.g., the first response) to the user question.

In some examples, user response information associated with a user response to the first AI-generated content item 556 and/or the first response may be recorded by the content system. The user response information may comprise (i) a view time of the first AI-generated content item 556 and/or the first response (e.g., how long the representation 561 of the first AI-generated content item 556 and/or the representation 580 of the first response is displayed on the first client device 500 and/or viewed by the first user of the first client device 500), (ii) user activity information indicative of user activity of the first user after being presented with the representation 561 of the first AI-generated content item 556 and/or the representation 580 of the first response, and/or (iii) other information. The user activity information may comprise an indication of whether the user navigated to a content item of the first group of content items 524 to find information the user was looking for (which may indicate that the first AI-generated content item 556 did not provide sufficient information to satisfy the user's needs, for example) and/or other user activity information. In some examples, the user response information associated with the first user and/or other users may be used as feedback to update one or more features of the content system, such as (i) update and/or train the generative AI system 614 (e.g., one or more tunable parameters of a machine learning model of the generative AI system 614 may be modified based upon the feedback to more accurately generate content, such as summaries and/or entity-focused articles, that users respond more positively to) and/or (ii) update and/or train the content extraction model to enhance performance of the content system. It may be appreciated that updating and/or training the content system, the generative AI system 614 and/or the content extraction model based upon user responses from users may create a closed-loop process allowing results of events in which content (e.g., AI-generated content and/or responses) is provided to users as feedback to tailor parameters of the content system, the generative AI system 614 and/or the content extraction model. Closed-loop control may reduce errors and produce more efficient operation of a computer system which implements the content system, the generative AI system 614 and/or the content extraction model. The reduction of errors and/or the efficient operation of the computer system may improve operational stability and/or predictability of operation. Accordingly, using processing circuitry to implement closed loop control described herein may improve operation of underlying hardware of the computer system.

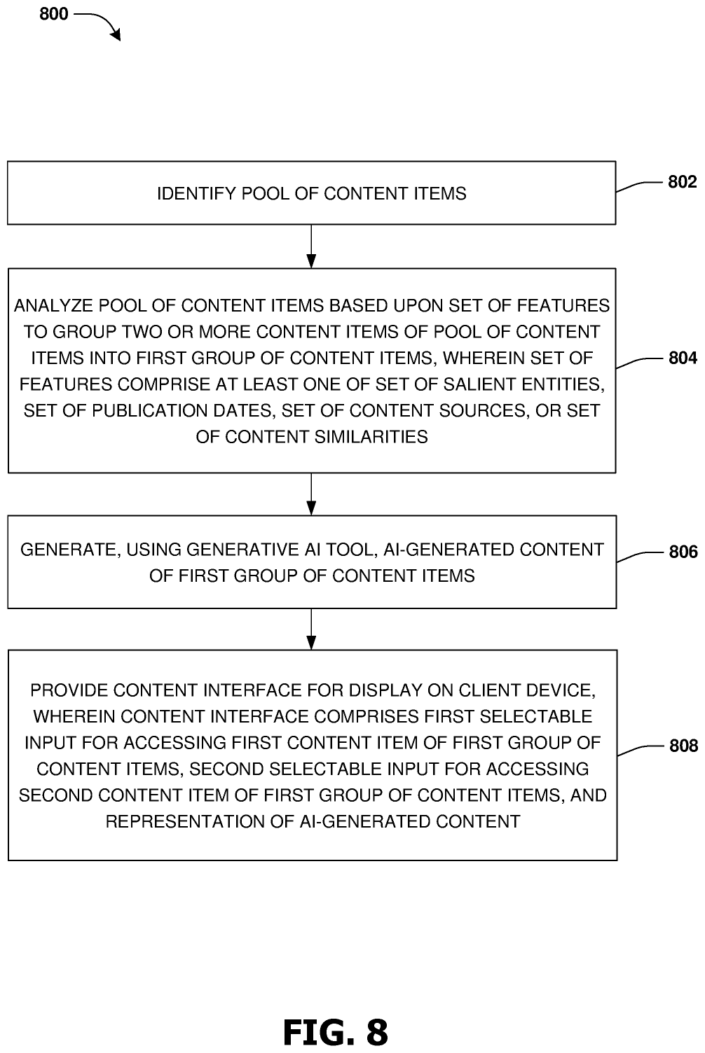

An embodiment of providing AI-generated content is illustrated by an example method 800 of FIG. 8. At least some of the example method 800 may be performed by the content system. At 802, a pool of content items may be identified. At 804, the pool of content items may be analyzed based upon a set of features to group two or more content items of the pool of content items into a first group of content items, wherein the set of features comprise a set of salient entities, a set of publication dates, a set of content sources and/or a set of content similarities. At 806, using a generative AI tool, an AI-generated content item based upon the first group of content items may be generated. At 808, a content interface may be provided for display on a client device, wherein the content interface comprises a first selectable input for accessing a first content item of the first group of content items, a second selectable input for accessing a second content item of the first group of content items, and/or a representation of the AI-generated content item.

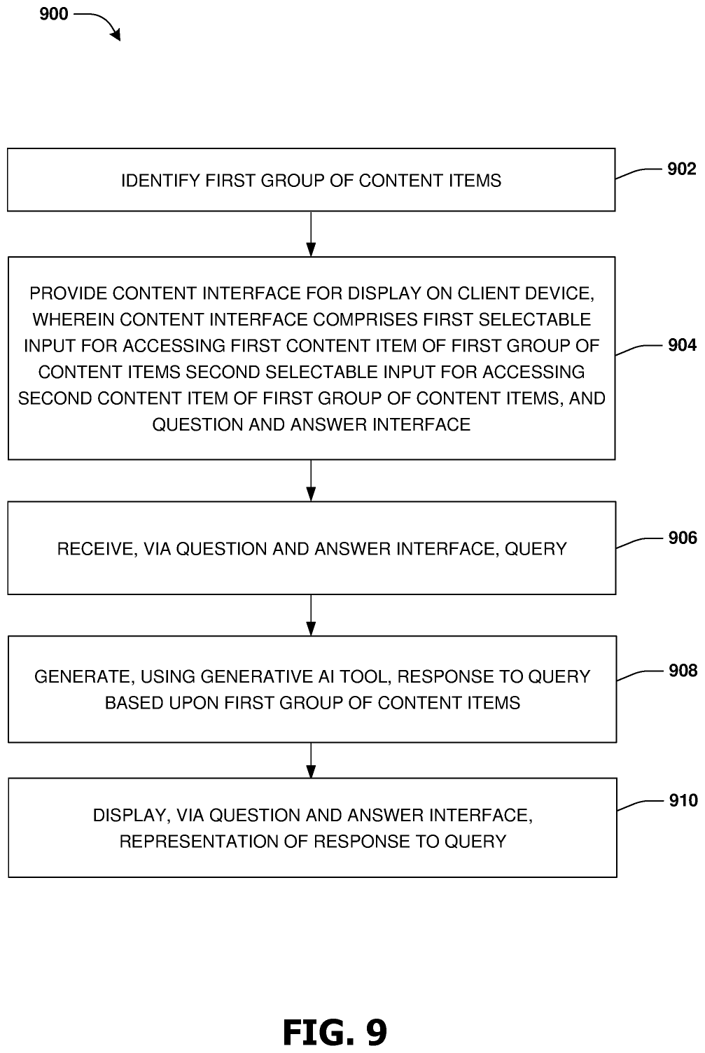

An embodiment of providing a question and answer interface is illustrated by an example method 900 of FIG. 9. At least some of the example method 800 may be performed by the content system. At 902, a first group of content items may be identified. At 904, a content interface may be provided for display on a client device, wherein the content interface comprises a first selectable input for accessing a first content item of the first group of content items, a second selectable input for accessing a second content item of the first group of content items, and/or a question and answer interface. At 906, a query may be received via the question and answer interface. At 908, using a generative AI tool, a response to the query may be generated based upon the first group of content items. At 910, a representation of the response to the query may be displayed via the question and answer interface.

It may be appreciated that the disclosed subject matter may assist a user in understanding main points of information associated with a story by automatically providing AI-generated content to the user. Alternatively and/or additionally, the disclosed subject matter may provide expanded content coverage of content provided by the content system, increased scalability of content creation, faster publishing speed to cover breaking news and evolving stories in a timely manner and/or adaptable content customization.

Implementation of at least some of the disclosed subject matter may lead to benefits including a reduction in screen space and/or an improved usability of a display (e.g., of a client device) (e.g., as a result of providing the first AI-generated content item 556 that may represent main points of desired information are automatically displayed via the client device, wherein the user may not be required to navigate through multiple web pages and/or open various tabs and/or windows to access the requested information, as a result of providing the question and answer interface 540 to provide a real-time contextual question answering service without a user having to navigate away to a different page, and/or manually sift through online information, thereby saving time and effort etc.).

Alternatively and/or additionally, implementation of at least some of the disclosed subject matter may lead to benefits including less manual effort (e.g., as a result of generating the first AI-generated content item 556 automatically, wherein manual editing to produce the summary is not required).

In some examples, the first client device 500 is configured to display a menu listing one or more features (e.g., selectable features) of the content system. The one or more features may comprise at least one of a search feature, a content feature, a messaging feature, a social media feed feature, etc. In an example, in response to a selection of the search feature, the search feature may provide one or more resources (e.g., the search interface 508, search functionality, etc.) for using the search engine of the content system to search for content. In an example, in response to a selection of the content feature, the content feature may provide one or more resources (e.g., the content interface 533 and/or other resources) for displaying and/or engaging with content items (e.g., AI-generated content and/or groups of content items, question and answer interface, videos, images, audio files, news articles, etc.). In response to a selection of the messaging feature, the messaging feature may provide one or more resources (e.g., data, an interface, etc.) for displaying and/or facilitating messaging conversations (e.g., private messaging conversations and/or public messaging conversations) between users of the content system (e.g., users of the content system may send messages to each other using the messaging feature of the content system). In response to a selection of the social media feed feature, the social media feed feature may provide one or more resources (e.g., data, an interface, etc.) for displaying social media posts and/or comments on a social media platform. In some examples, the client device is configured to display a content platform application summary that can be reached directly from the menu, wherein the content platform application summary displays a limited list of data offered within the one or more features. In some examples, each of the data in the limited list of data is selectable to launch the respective feature (of the one or more features) and enable the selected data to be seen within the respective feature. In some examples, the content platform application summary is displayed while the one or more features are in an un-launched and/or unopened state.

In some examples, at least some of the disclosed subject matter may be implemented on a client device, and in some examples, at least some of the disclosed subject matter may be implemented on a server (e.g., hosting a service accessible via a network, such as the Internet).

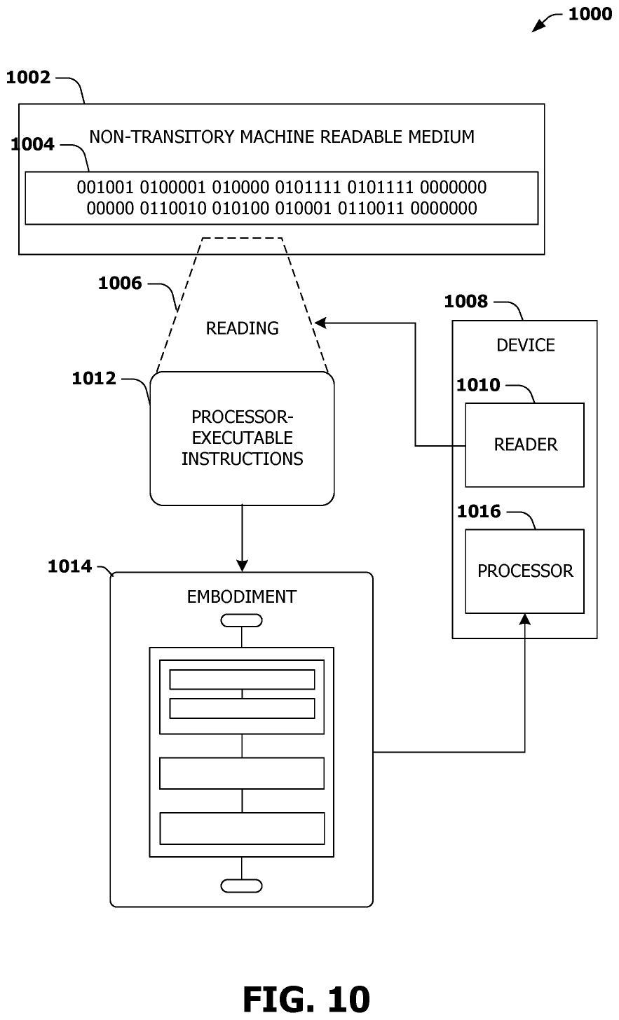

FIG. 10 is an illustration of a scenario 1000 involving an example non-transitory machine readable medium 1002. The non-transitory machine readable medium 1002 may comprise processor-executable instructions 1012 that when executed by a processor 1016 cause performance (e.g., by the processor 1016) of at least some of the provisions herein (e.g., embodiment 1014). The non-transitory machine readable medium 1002 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 1002 stores computer-readable data 1004 that, when subjected to reading 1006 by a reader 1010 of a device 1008 (e.g., a read head of a hard disk drive, or a read operation invoked on a solid-state storage device), express the processor-executable instructions 1012. In some embodiments, the processor-executable instructions 1012, when executed, cause performance of operations, such as at least some of the example method 400 of FIG. 4, at least some of the example method 800 of FIG. 8 and/or at least some of the example method 900 of FIG. 9, for example. In some embodiments, the processor-executable instructions 1012 are configured to cause implementation of a system, such as at least some of the example system 501 of FIGS. 5A-5H, at least some of the example system 601 of FIG. 6 and/or at least some of the example system 701 of FIG. 7, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
identifying a pool of content items;
analyzing the pool of content items based upon a set of features to group two or more content items of the pool of content items into a first group of content items, wherein the set of features comprise at least one of:
a set of salient entities;
a set of publication dates;
a set of content sources; or
a set of content similarities;
generating, using a generative artificial intelligence (AI) tool, an AI-generated content item based upon the first group of content items; and
providing a content interface for display on a client device, wherein the content interface comprises:
a first selectable input for accessing a first content item of the first group of content items;
a second selectable input for accessing a second content item of the first group of content items; and
a representation of the AI-generated content item.

2. The method of claim 1, wherein generating the AI-generated content item comprises:
generating the AI-generated content item based upon one or more entities of the set of salient entities.

3. The method of claim 1, wherein generating the AI-generated content item comprises:
generating a prompt instructing the generative AI tool to generate the AI-generated content item to focus on one or more entities of the set of salient entities; and
submitting the prompt and content of the first group of content items to the generative AI tool.

4. The method of claim 3, comprising:
extracting the content from the first group of content items, wherein the content excludes at least one of a structural element, a link, a header, or metadata included in the first group of content items.

5. The method of claim 1, wherein the content interface comprises:
a third selectable input for displaying the AI-generated content item.

6. The method of claim 5, comprising:
displaying the representation of the AI-generated content item in response to a selection of the third selectable input.

7. The method of claim 1, wherein identifying the pool of content items comprises:
scanning a plurality of internet resources to identify content items provided by internet resources of the plurality of internet resources; and
extracting the content items from the internet resources for inclusion in the pool of content items.

8. The method of claim 1, comprising:
receiving, from the client device, a query;
in response to the query, generating a plurality of search results corresponding to a plurality of internet resources associated with the query; and
extracting content items from the plurality of internet resources for inclusion in the pool of content items.

9. The method of claim 1, wherein grouping the two or more content items of the pool of content items into the first group of content items comprises:
grouping the first content item and the second content item into the first group of content items based upon:
the first content item being associated with a first content source of the set of content sources; and
the second content item being associated with a second content source, of the set of content sources, different than the first content source.

10. The method of claim 1, comprising:
determining one or more first metrics associated with the first group of content items and the AI-generated content item; and
displaying, via the content interface, a representation of the one or more first metrics.

11. A non-transitory machine-readable medium having stored thereon processor-executable instructions that when executed cause performance of operations, the operations comprising:
identifying a first group of content items;
providing a content interface for display on a client device, wherein the content interface comprises:
a first selectable input for accessing a first content item of the first group of content items;
a second selectable input for accessing a second content item of the first group of content items; and
a question and answer interface;
receiving, via the question and answer interface, a query;
generating, using a generative artificial intelligence (AI) tool, a response to the query based upon the first group of content items; and
displaying, via the question and answer interface, a representation of the response to the query.

12. The non-transitory machine-readable medium of claim 11, wherein generating the response comprises:
generating a prompt instructing the generative AI tool to provide the response to the query using content of the first group of content items; and
submitting the prompt and the content to the generative AI tool.

13. The non-transitory machine-readable medium of claim 11, comprising:
generating a summary of the first group of content items; and
displaying a representation of the summary via the content interface.

14. A computing device comprising:
a processor; and
memory comprising processor-executable instructions that when executed by the processor cause performance of operations, the operations comprising:
identifying a pool of content items;
analyzing the pool of content items based upon a set of features to group two or more content items of the pool of content items into a first group of content items;
generating, using a first generative artificial intelligence (AI) tool, an AI-generated content item based upon the first group of content items;
providing a content interface for display on a client device, wherein the content interface comprises:
a representation of the AI-generated content item; and
a question and answer interface;
receiving, via the question and answer interface, a query;
generating, using a second generative AI tool, a response to the query; and
displaying, via the question and answer interface, a representation of the response to the query.

15. The computing device of claim 14, wherein:
the first generative AI tool is the same as the second generative AI tool.

16. The computing device of claim 14, wherein:
the first generative AI tool is different than the second generative AI tool.

17. The computing device of claim 14, the operations comprising:
determining one or more first metrics associated with the first group of content items and the AI-generated content item; and
displaying, via the content interface, a representation of the one or more first metrics.

18. The computing device of claim 14, wherein generating the AI-generated content item comprises:
generating a prompt instructing the first generative AI tool to produce a summary, of content of the first group of content items, that focuses on one or more entities; and
submitting the prompt and the content to the first generative AI tool.

19. The computing device of claim 18, the operations comprising:
extracting the content from the first group of content items, wherein the content excludes at least one of a structural element, a link, a header, or metadata included in the first group of content items.

20. The computing device of claim 14, wherein:
the content interface comprises a third selectable input for displaying the AI-generated content item; and
the content interface displays the representation of the AI-generated content item in response to a selection of the third selectable input.
